(19) United States
(12) Patent Application Publication
(10) Pub. No.: US 2011/0012890 A1
(43) Pub. Date: Jan. 20, 2011

(54) DISPLAY APPARATUS AND DISPLAY METHOD

(75) Inventors: Soo-hong KIM, Suwon-si (KR); Myeong-hwan KIM, Suwon-si (KR); Sae-hoon KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/727,771

(22) Filed: Mar. 19, 2010

(30) Foreign Application Priority Data
Jul. 17, 2009 (KR) 10-2009-0065579

(51) Int. Cl. G06F 3/038

(52) U.S. Cl. 345/213; 345/214

(57) ABSTRACT

An apparatus and method for partially driving a plasma display panel (PDP) includes a PDP with a plurality of bus electrodes, and a plurality of addressing electrodes intersecting the plurality of bus electrodes to create a display area for displaying an image frame. A panel driver selectively drives the plurality of bus and addressing electrodes, and a controller controls the panel driver to exclude from driving at least one among the plurality of bus electrodes and addressing electrodes with respect to a partial area of the PDP. By only partially driving a portion of the PDP, the loads to be driven, costs of the driving, and power consumption can be reduced. Further, the quality and the brightness of an image can be improved by increasing the number of subfields or increasing a sustaining period by an amount of time corresponding to the time saved by excluding the partial area from driving.

### CROSS-REFERENCE TO RELATED APPLICATION

This application claims priority from Korean Patent Application No. 10-2009-0065579, filed on Jul. 17, 2009 in the Korean Intellectual Property Office, the disclosure of which is incorporated herein by reference.

### BACKGROUND

1. Field

Apparatuses and methods consistent with exemplary embodiments relate to a display apparatus and a display method, and more particularly, to a display apparatus and a display method in which a plasma display panel is partially driven by omitting driving of a partial region.

2. Description of the Related Art

A plasma display apparatus displays an image using plasma generated by gas discharge. The plasma display apparatus divides and drives one frame into a plurality of subfields each having a weight. Each subfield undergoes a resetting period, an addressing period and a sustaining period in sequence.

During the resetting period, a status of a cell is initialized to smoothly apply an addressing operation to a cell.

During the addressing period, a cell to be turned on and a cell to be turned off are selected on the panel. At this period, the plasma display apparatus applies an addressing voltage to the cell to be turned on (i.e., an addressed cell) and accumulates wall-charges.

During the sustaining period, a discharge is performed by applying a sustaining discharge pulse to actually display an image on the addressed cell. At this period, the sustaining discharge pulse alternating between a high level voltage (e.g., Vs) and a low level voltage (e.g., 0V) is applied in opposite phases to a scanning electrode and a sustaining electrode.

The plasma display apparatus drives all cells fully to apply signals to all pixels displayed on a screen. Due to driving properties of a plasma display panel, a considerable portion (about 70%) of time taken in displaying one frame is consumed in addressing and erasing. Therefore, the brightness of an image decreases, and costs of driving the plasma display panel increases.

### SUMMARY

Accordingly, one exemplary embodiment is to provide a display apparatus and a display method in which a plasma display panel is partially driven by omitting driving of a partial region.

The foregoing and other exemplary embodiments can be achieved by providing a display apparatus including: a plasma display panel which includes a plurality of bus electrodes, and a plurality of addressing electrodes intersecting the plurality of bus electrodes to form a display area; a panel driver which selectively drives the plurality of bus electrodes and the plurality of addressing electrodes; and a controller which controls the panel driver to exclude from driving at least one of the plurality of bus electrodes and addressing electrodes with respect to a partial area of the plasma display panel.

The partial area of the plasma display panel may correspond to an area other than an effective area of the display area for an input image.

The partial area may be located on at least one of a left side and a right side of the plasma display panel, wherein only at least one of the plurality of addressing electrodes is excluded from driving.

The partial area may be located on at least one of a top side and a bottom side of the plasma display panel.

The plasma display panel may display an image frame with a number of subfields of discharging times, wherein the number of subfields per image frame is increased by the controller based on an amount of time saved by excluding the driving of the partial area of the plasma display panel.

The plasma display panel may display an image frame, wherein the image frame further comprises a section added by the controller for preventing an afterglow, wherein a size of the section is based on an amount of time saved by excluding the driving of the partial area of the plasma display panel.

The bus electrode may include a sustaining period, and the sustaining period is increased by the controller by an amount of time corresponding to a time saved by excluding the driving of the partial area of the plasma display panel.

The partial area may correspond to an area where no image is displayed, if an aspect ratio of an input image is not similar to an aspect ratio of the plasma display panel.

The display apparatus may further include a user input unit which allows a user to select the partial area.

The partial area selected through the user input unit may be excluded from driving by the controller.

Another exemplary embodiment can be achieved by providing a display method including: selecting a partial area from a display area on a plasma display panel, where the display area comprises a plurality of bus electrodes and a plurality of addressing electrodes intersecting the plurality of bus electrodes; driving the plurality of bus electrodes and plurality of addressing electrodes, excluding the partial area, the partial area comprising at least one of the plurality of bus electrodes and addressing electrodes; and displaying an image frame of the driven display area on the plasma display panel.

The display method may further include excluding the partial area of the plasma display panel that corresponds to an area other than an effective area of the display area for an input image.

The display method may further include excluding a partial area located on at least one of a left side and/or a right side of the plasma display panel, such that only at least one of the addressing electrodes is excluded from driving.

The display method may further include excluding a partial area located on at least one of a top side and a bottom side of the plasma display panel.

The display method may further include increasing a number of subfields constituting an image frame based on an amount of time saved by excluding the driving of the partial area of the plasma display panel.

The display method may further include adding a section to the image frame for preventing an afterglow, wherein the size of the section is based on an amount of time saved by excluding the driving of the partial area of the plasma display panel.

The display method may further include increasing a sustaining period of the bus electrode by an amount of time corresponding to a time saved by excluding the driving of the partial area of the plasma display panel.

The display method may further include excluding a partial area where no image is displayed, if an aspect ratio of an input image is not similar to an aspect ratio of the plasma display panel.

The display method may further include allowing a user to select the partial area.

The display method may further include excluding the partial area selected by user from driving.

### BRIEF DESCRIPTION OF THE DRAWINGS

The above and/or other aspects of the exemplary embodiments will become apparent and more readily appreciated from the following description of the exemplary embodiments, taken in conjunction with the accompanying drawings, in which:

FIG. 1 is a block diagram of a display apparatus according to an exemplary embodiment;

FIG. 2A shows one aspect where a left area and a right area of a screen display no image;

FIG. 2B shows a further aspect including electrodes for which driving is excluded;

FIG. 3A shows one exemplary embodiment where a top area and a bottom area of a screen display no image;

FIG. 3B shows one exemplary embodiment illustrated in FIG. 3A, including electrodes for which driving is excluded;

FIG. 4A shows a frame driven in accordance with a general aspect;

FIG. 4B shows a frame driven in accordance with an exemplary embodiment;

FIG. 4C shows a frame driven in accordance with another exemplary embodiment;

FIG. 4D shows a frame driven in accordance with still another exemplary embodiment;

FIG. 5A shows a frame for displaying a 3D image that is driven in accordance with a general aspect;

FIG. 5B shows a frame for displaying a 3D image that is driven in accordance with an exemplary embodiment;

FIG. 5C shows a frame for displaying a 3D image, driven in accordance with another exemplary embodiment;

FIG. 5D shows a frame for displaying a 3D image, driven according to still another exemplary embodiment;

FIG. 6 shows display areas according to an exemplary embodiment; and

FIG. 7 is a flowchart depicting a process for partially driving a partial region of a display, according to an exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout. Expression such as “at least one of,” when preceding a list of elements, modifies the entire list of elements and does not modify each element of the list.

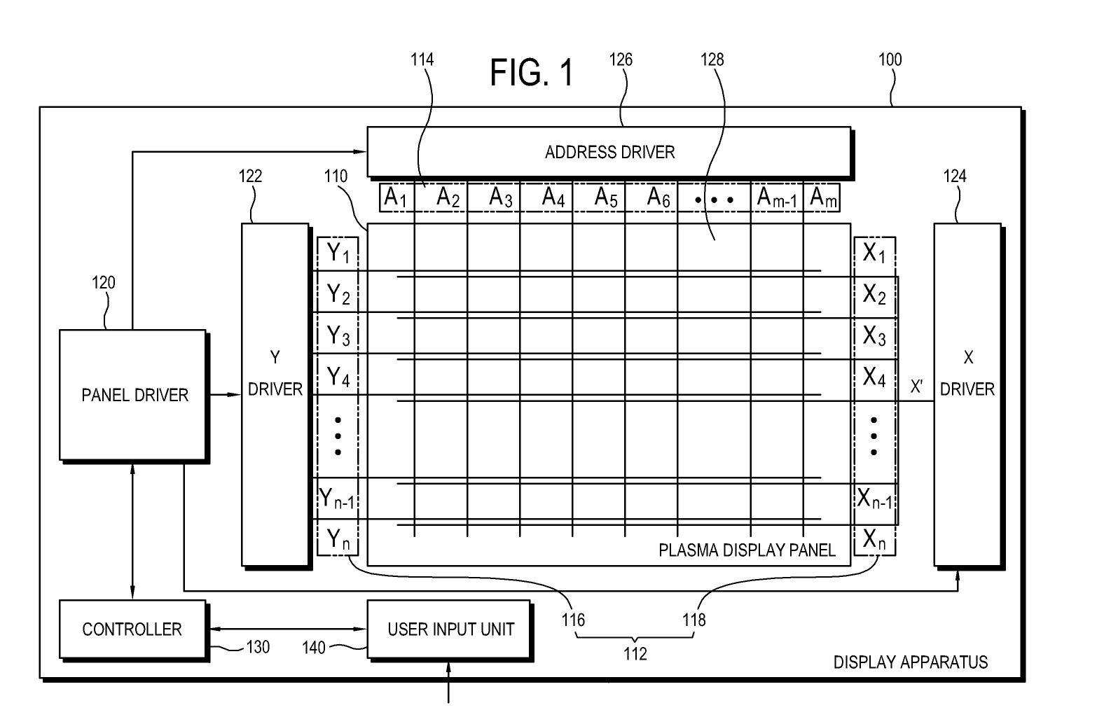

FIG. 1 is a block diagram of a display apparatus according to an exemplary embodiment.

In this exemplary embodiment, a display apparatus 100 may include a digital television (TV), a monitor, a desktop computer, a notebook computer, a mobile terminal, etc. Furthermore, any electronic device can be employed as the display apparatus 100 in this exemplary embodiment as long as it includes a plasma display panel (PDP) and displays an image by a PDP driving method.

The display apparatus 100 in this exemplary embodiment may include a plasma display panel 110, a panel driver 120, a controller 130, and a user input unit 140.

The plasma display panel 110 includes a plurality of bus electrodes 112, and a plurality of addressing electrodes 114 intersecting the plurality of bus electrodes.

The bus electrode 112 may include an electrode for performing a scanning function and a sustaining function. According to an exemplary embodiment, the bus electrodes 112 include a plurality of scanning electrodes 116 (Y electrodes) for scanning, and a plurality of sustaining electrodes 118 (X electrodes) for sustaining. Here, the plurality of scanning electrodes 116 and sustaining electrodes 118 intersects the plurality of addressing electrodes 114, and thus cells 128 may be provided in the form of a matrix.

The addressing electrode may designate a position of a cell 128 to be driven.

Referring to FIG. 1, the bus electrodes 112 include a plurality of scanning electrodes 116 (Y1, Y2, Y3, Y4, . . . , Yn−1, Yn) and a plurality of sustaining electrodes 118 (X1, X2, X3, X4, . . . , Xn−1, Xn). In this case, the plurality of scanning electrodes 116 are provided independently of one another, and connected to a Y driver 122. The plurality of sustaining electrodes 118 are connected in parallel with one another by one common sustaining electrode X′ and connected to an X driver 124. The plurality of addressing electrodes 114 (A1, A2, A3, A4, . . . , Am−1, Am) are connected to an address driver 126.

The panel driver 120 may selectively drive the plurality of bus electrodes 112 and addressing electrodes 114. The panel driver 120 includes the Y driver 122, the X driver 124 and the address driver 126.

To drive the plasma display panel 110, the panel driver 120 selects a cell 128 through the address line and applies a sustain signal to sustain a discharge of the selected cell.

According to an exemplary embodiment, the panel driver 120 may exclude at least one among the plurality of addressing electrodes 114 from driving, with respect to a partial area placed in a left side and/or a right side of the plasma display panel 110. For example, it is possible to exclude, or skip, the driving of the addressing electrodes A1 to A4 for driving the cells included in a partial area placed in the left side.

According to another exemplary embodiment, the panel driver 120 may exclude the driving of at least one among the plurality of bus and addressing electrodes, with respect to a partial area placed in a top side and/or a bottom side of the plasma display panel 110. For example, it is possible to skip driving the scanning electrodes Y1 to Y4, the sustaining electrodes X1 to X4, and the addressing electrodes A1 to A4 for driving the cells included in a partial area placed in the top side.

In this case, the partial area of the plasma display panel 110 displays no image.

In another aspect, the controller 130 may control the panel driver 120 to exclude the driving of at least one among the plurality of bus and addressing electrodes with respect to a partial area of the plasma display panel 110. Specifically, the controller 130 may control the panel driver 120 and skip driving at least one among the plurality of bus and addressing electrodes, with respect to a partial area of the plasma display panel 110 other than an effective display area for an input image. For this aspect, the controller 130 may apply a video signal along with a control signal for selectively driving an area of the plasma display panel 110 to the panel driver 120.

If a partial area to be excluded is located in the left side and/or the right side of the plasma display panel 110, the controller 130 may control the panel driver 120 to skip driving the addressing electrodes with respect to this partial area.

If a partial area to be excluded is located in the top side and/or the bottom side of the plasma display panel 110, the controller 130 may control the panel driver 120 to skip driving the bus and addressing electrodes with respect to this partial area.

If at least one bus electrode is excluded from driving with respect to a partial area of the plasma display panel 110, an addressing operation corresponding to the excluded area can be also excluded, and thus total time taken in driving one frame can be relatively shortened. In this case, it is possible to save time for driving as much time as shortened.

According to an exemplary embodiment, the controller 130 may control the panel driver 120 to increase the number of subfields constituting an image frame, within the time saved by skipping the driving.

According to another exemplary embodiment, the controller 130 may control the panel driver 120 to add a section for preventing an afterglow, within the time saved by skipping the driving.

According to still another exemplary embodiment, the controller 130 may control the panel driver 120 to increase a sustain time of the bus electrode, within the time saved by skipping the driving.

Meanwhile, if an aspect ratio of an input image is not similar to that of the plasma display panel 110, the controller 130 may control the panel driver 120 to skip driving at least one among the plurality of bus and addressing electrodes with respect to a partial area where no image is displayed.

Further, the controller 130 may control the panel driver 120 to skip driving at least one among the plurality of bus and addressing electrodes with respect to a partial area selected by a user. Specifically, the controller 130 may control the panel driver 120 to skip driving at least one among the plurality of bus and addressing electrodes with respect to a partial area selected through a user input unit 140, as described further below.

The user input unit 140 may allow a user to select a partial area.

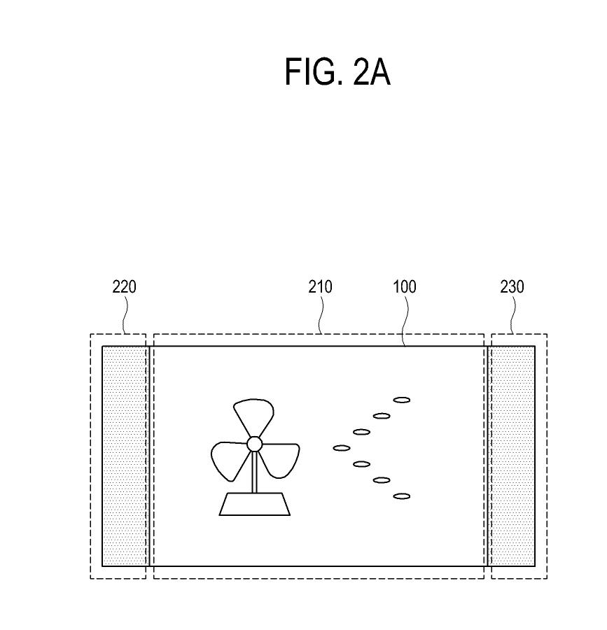

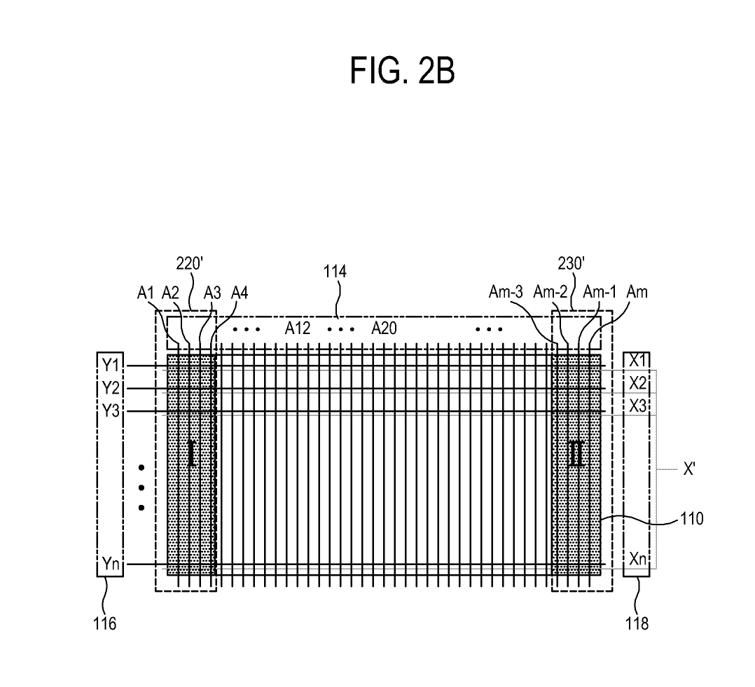

FIG. 2A shows one aspect where a left area and a right area of a screen display no image.

If an input image has a horizontal-to-vertical ratio, or aspect ratio, less than that of the aspect ratio of the display apparatus 100, a left area 220 and a right area 230 of a screen display no image. For example, if an image having an aspect ratio of 4:3 is input to the display apparatus 100 having an aspect ratio of 16:9, the input image is displayed on only an area 210 other than the left area 220 and the right area 230.

FIG. 2B shows electrodes for which driving is excluded as discussed above with regard to FIG. 2A.

To display an image on the left area 220 of the screen shown in FIG. 2A, a plurality of electrodes included in an area I 220′ has to be driven. Also, to display an image on the right area 230 of the screen shown in FIG. 2A, a plurality of electrodes included in an area II 220′ has to be driven.

Since the scanning electrode 116 and the sustaining electrode 118 are driven according to lines, partial control is not allowed in a vertical direction. For example, in FIG. 2B, it is impossible to drive the scanning electrode Y1 and the sustaining electrode X1 only in the area other than the area I 220′ and the area II 230′.

Thus, the display apparatus 100 does not drive the addressing electrodes for driving the cells included in the area I 220′ and the area II 230′ where no image is displayed. Referring to FIG. 2B, the addressing electrode 114 for driving the cells included in the area I 220′ includes the addressing electrodes A1, A2, A3 and A4, and the addressing electrode 114 for driving the cells included in the area II 230′ includes the addressing electrodes Am−3, Am−2, Am−1 and Am. Thus, the display apparatus 100 does not drive the addressing electrodes pertaining to area I 220′ and area II 230′. To this end, the display apparatus 100 sends the panel driver 120 information about an area having no need of driving, thereby skipping an addressing operation with respect to the area having no need of driving.

Existing plasma display apparatuses fully drive all driving blocks constituting a screen. That is, even sections unnecessary for displaying an image, e.g., the left area 220′, the right area 230′ and a blank section of FIG. 2B are driven.

Referring to FIG. 2B, if an input image has an aspect ratio unmatched with that of the display apparatus 100, the display apparatus 100 sends a video signal together with information about an area having no need of driving to a driving block, thereby skipping the addressing operation with respect to an area having no need of driving. In this case, an amount of time is saved equivalent to the time required to complete the addressing operation that is now being excluded, and it is possible to reduce power consumption due to driving fewer addressing electrodes and also decrease a temperature stress generated in a driving block.

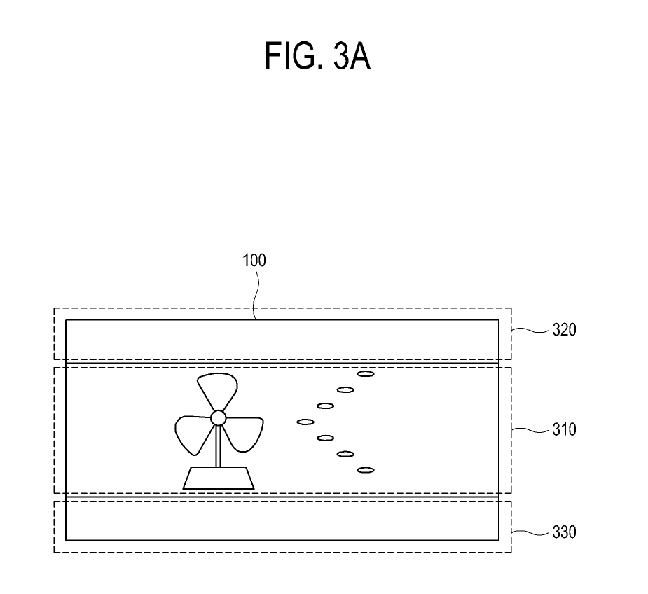

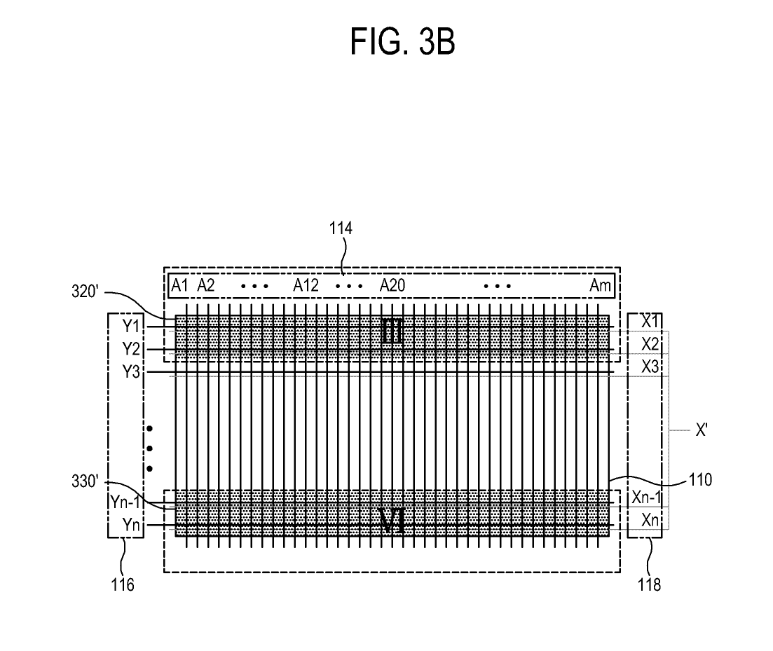

FIG. 3A shows one aspect where a top area and a bottom area of a screen display no image.

If an input image has a horizontal-to-vertical ratio, or aspect ratio, greater than that of the aspect ratio of the display apparatus 100, a top area 320 and a bottom area 330 of a screen display no image. For example, if a wide image having an aspect ratio of 1.85:1 is input to the display apparatus 100 having an aspect ratio of 16:9, the input image is displayed on only an area 310 other than the top area 320 and the bottom area 330.

FIG. 3B shows electrodes for which driving is excluded as discussed above with regard to FIG. 3A.

To display an image on the top area 320 of the screen shown in FIG. 3A, a plurality of electrodes included in an area III 320′ of FIG. 3B has to be driven. Also, to display an image on the bottom area 330 of the screen shown in FIG. 3A, a plurality of electrodes included in an area IV 330′ of FIG. 3B has to be driven.

Since the scanning electrode 116 and the sustaining electrode 118 are driven according to lines, partial control is allowed in a horizontal direction. Thus, the display apparatus 100 does not drive the address electrodes 114, scanning electrodes 116 and sustaining electrodes 118 for driving the cells included in the area III 320′ and the area IV 330′ where no image is displayed. Referring to FIG. 3B, the addressing electrode for driving the cells included in the area III 320′ includes the scanning electrodes Y1 and Y2, the sustaining electrodes X1 and X2, and the addressing electrodes A1 to Am. Also, in FIG. 3B, the electrode for driving the cells included in the area IV 330′ includes the scanning electrodes Yn−1 and Yn, the sustaining electrodes Xn−1 and Xn, and the addressing electrodes A1 to Am. Thus, the display apparatus 100 does not drive the addressing electrodes with respect to some areas. To this end, the display apparatus 100 sends the panel driver 120 information about an area having no need of driving, thereby skipping an addressing operation, a scanning operation and a sustaining operation with respect to the area having no need of driving.

Referring to FIG. 3B, the addressing operation, the scanning operation, the sustaining operation, and an operation for driving an area of which driving will be excluded are all excluded from driving with respect to the corresponding areas III 320′ and IV 330′, thereby shortening a driving time. In this case, the scanning and sustaining electrodes as well as the addressing electrode are excluded, so that a black image may be displayed on the corresponding area. On the other hand, partial control for the scanning and sustaining electrodes is not currently allowed in the vertical direction, and it is thus impossible to display a complete black image on the corresponding areas I 220′ and II 230′ shown in FIG. 2B.

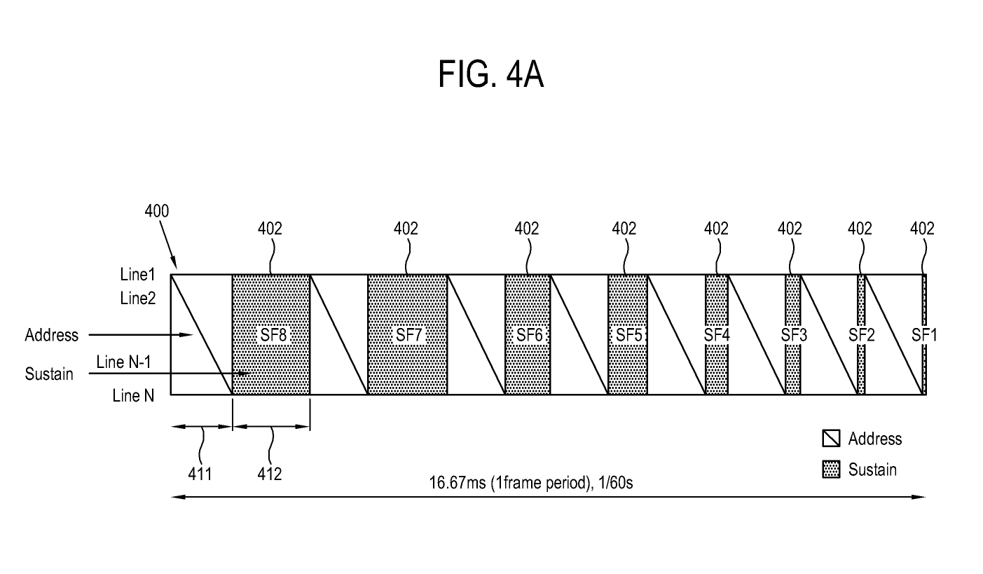

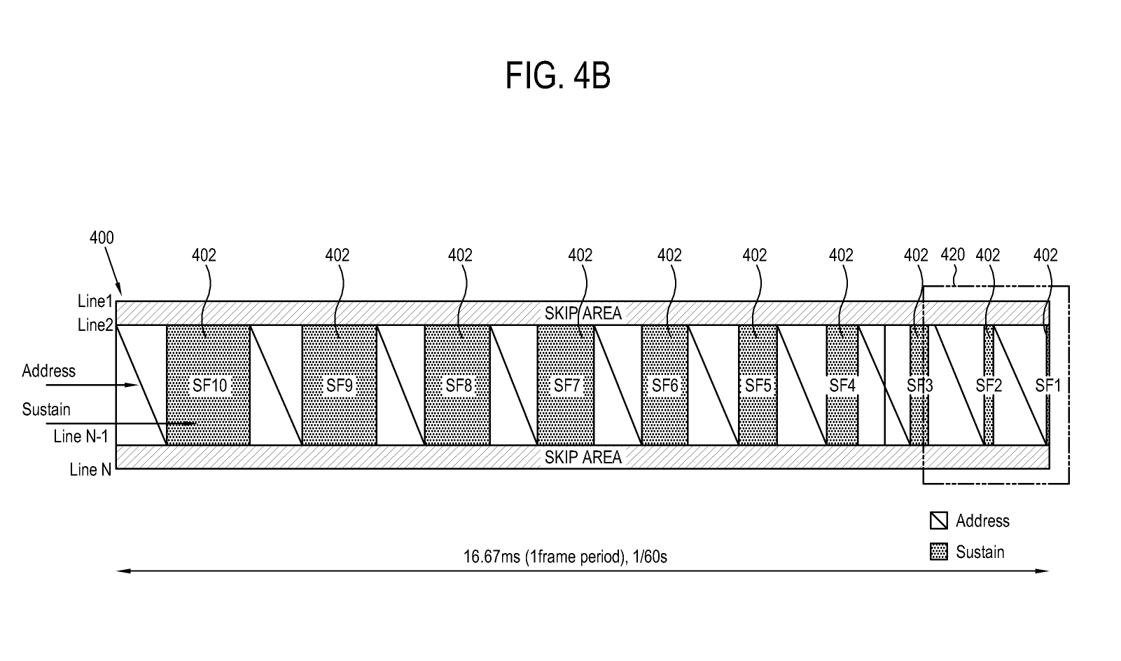

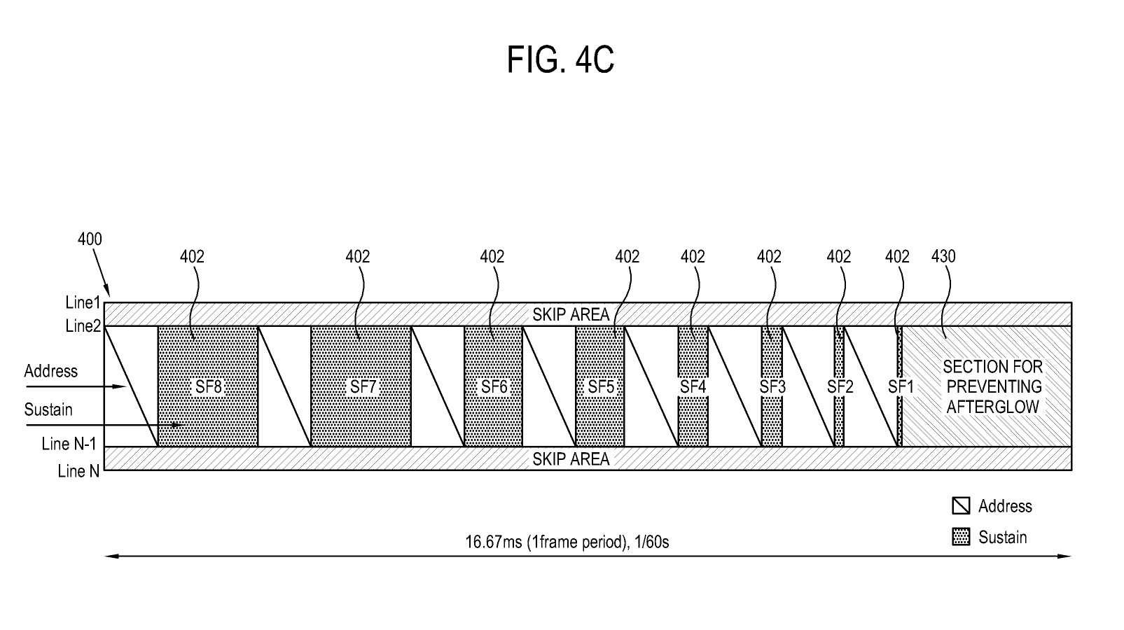

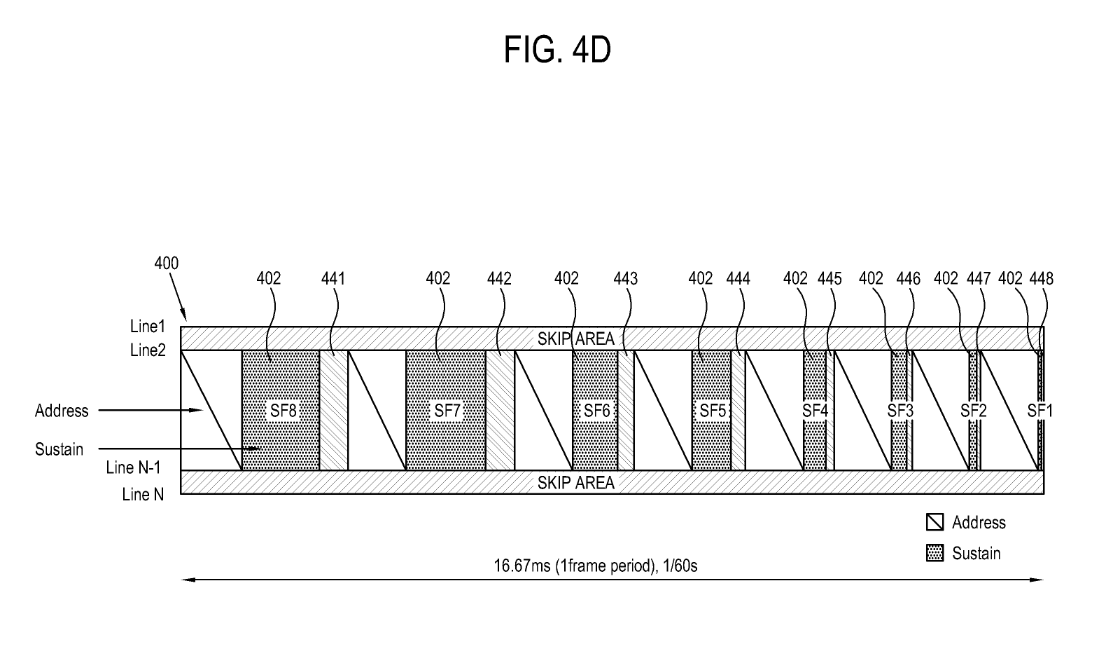

FIG. 4A shows a frame driven in accordance with a general aspect.

In the case of the PDP driving method, it is difficult to adjust the amount of electric discharge. Thus, a grayscale of each cell is achieved by the number of discharging times per unit time. If the number of discharging times for each cell per frame ranges from 0 to 2X−1 times, the brightness of each cell is varied depending on the number of discharging times during one frame. As a result, an image represented by 2X grayscales, i.e., an image having one of 0 to 2X−1 levels in each cell can be displayed on the whole screen. To this end, in this PDP driving method, each cell alternates between on and off statuses, and one frame is divided into X subfields different in the number of discharging times (i.e., different in a period of sustaining the electric discharge).

To represent 256 grayscales, one frame 400 is generally divided into 8 subfields 402. Referring to FIG. 4A, 8 subfields 402 (SF1, SF2, SF3, SF4, SF5, SF6, SF7 and SF8) are driven in sequence during one frame period for displaying one frame 400.

In this case, each subfield 402 is driven undergoing the addressing period and the sustaining period in sequence. During the addressing period, the addressing operation is performed to designate a position of a cell to be driven. During the sustaining period, the sustaining operation is performed to sustain the electric discharge for displaying an image.

Referring to FIG. 4A, a section 411 corresponds to an addressing period during which the addressing operation is applied to the subfield 8 SF8, and a section 412 corresponds to a sustaining period during which the electric discharge is sustained for the subfield 8 SF8. Likewise, each of the subfields 402 (SF7 to SF1) undergo the addressing period and the sustaining period. As a result, referring to FIG. 4A, the subfield SF8, the subfield SF7, the subfield SF6, the subfield SF5, the subfield SF4, the subfield SF3, the subfield SF2 and the subfield SF1 are driven in sequence, undergoing the addressing and sustaining periods, respectively.

FIG. 4B shows a frame 400 driven according to an exemplary embodiment.

In this exemplary embodiment, the display apparatus 100 may increase the number of subfields 402 constituting an image frame by up to an amount of time saved by skipping the driving. Specifically, the number of subfields added as long as the time required to process the subfields corresponds to the time saved by partially driving the plasma display panel 110. Referring to FIG. 4B, two subfields SF1 and SF2 are added to a section 420. Thus, the driving of one frame is divided into 10 subfields.

In the existing PDP driving method, the driving of one frame is divided into 8 subfields during one frame period, thereby representing 256 grayscales. Referring to FIG. 4B, the driving of one frame is divided into 10 subfields during one frame period, thereby representing 1024 grayscales. Accordingly, it is possible to represent minute grayscales and improve the quality of an image.

In this exemplary embodiment, the number of subfields added corresponds to the amount of time saved by skipping the addressing operations, the scanning operations and the sustaining operations with respect to a partial area, so that minute grayscales can be represented and the image quality can be enhanced without additional configurations.

FIG. 4C shows a frame 400 driven according to another exemplary embodiment.

In this exemplary embodiment, a section 430 for preventing an afterglow when an image frame is changed may be added, where the section corresponds to an amount of time saved by skipping the driving. Specifically, the section 430 for preventing the afterglow may be added as long as the time required to process the added section corresponds to the time saved by partially driving the plasma display panel 110. In this case, the section for preventing the afterglow may include a blank section or a subfield for preventing the afterglow. Also, the display apparatus 100 may apply a waveform for suppressing the afterglow or an erasing waveform during the section for preventing the afterglow. Referring to FIG. 4C, the section for preventing the afterglow is section 430.

When the plasma display panel is partially driven, the brightness may decrease as a result of a temperature increase in a part being partially driven, and the afterglow may arise according to changes in color coordinates. Further, the afterglow may be generated if a lot of still images are displayed.

In this exemplary embodiment, the length of the section for preventing the afterglow is based on the amount of time saved by skipping the driving of a partial area, thereby preventing the afterglow.

FIG. 4D shows a frame driven according to still another exemplary embodiment.

In this exemplary embodiment, the display apparatus 100 may increase the sustaining period for the bus electrode by an amount of time corresponding to the time saved by skipping the driving. Specifically, the period of sustaining the electric discharge of each subfield may increase within the time saved by partially driving the plasma display panel 110. Referring to FIG. 4D, the periods of sustaining the electric charges in the subfields are added as much as the section 441 for the subfield SF8, the section 442 for the subfield SF7, the section 443 for the subfield SF6, the section 444 for the subfield SF5, the section 445 for the subfield SF4, the section 446 for the subfield SF3, the section 447 for the subfield SF2, and the section 448 for the sub field SF1, respectively.

In this exemplary embodiment, the period of sustaining the electric discharge of each subfield increases by an amount of time corresponding to the time saved by skipping the driving with respect to a partial area, thereby increasing the brightness of an image.

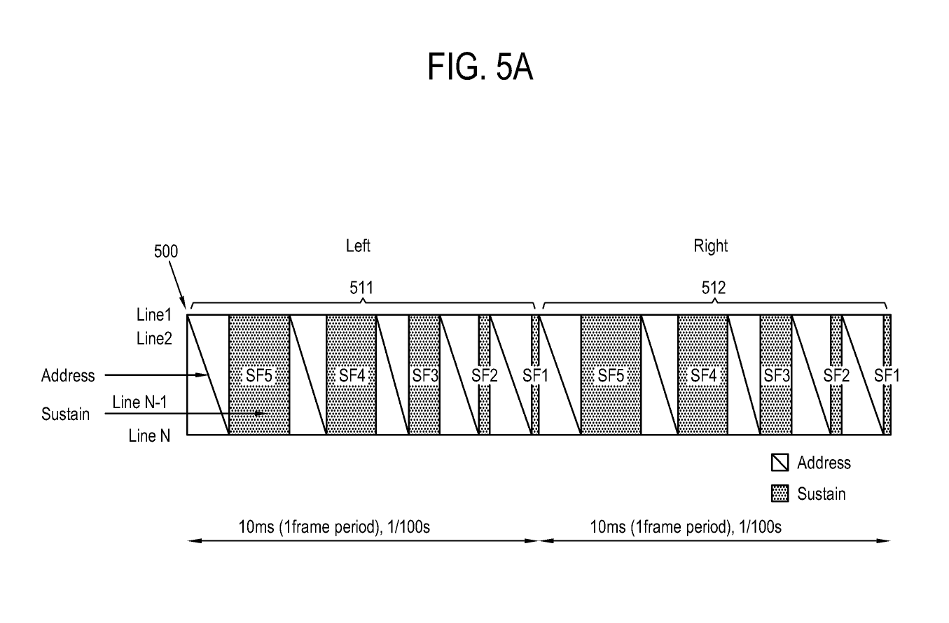

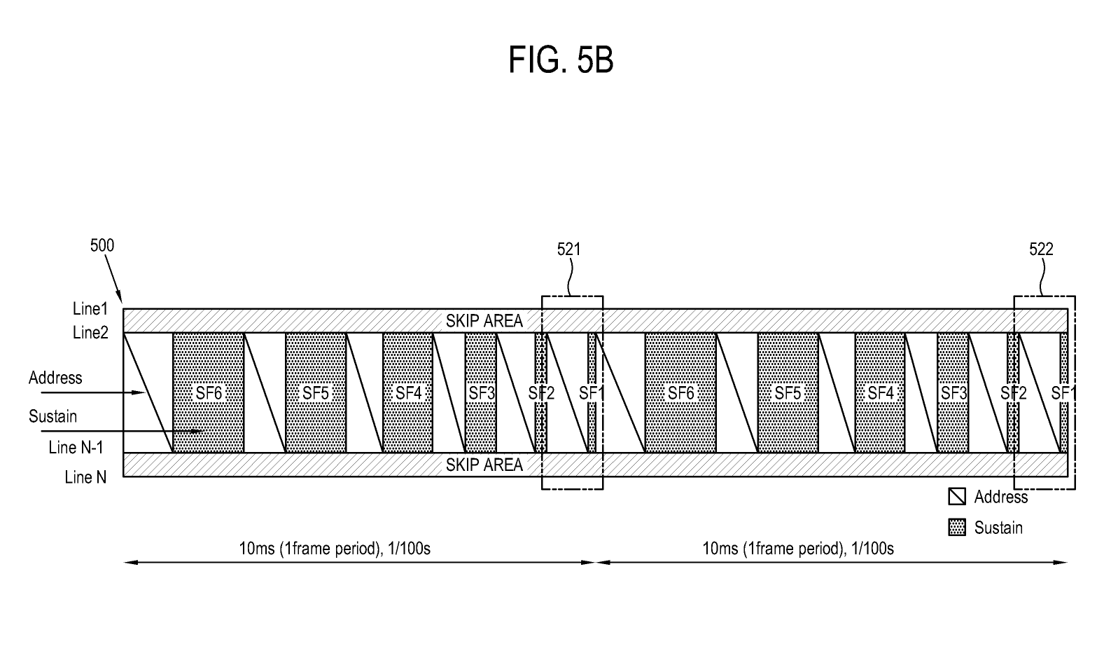

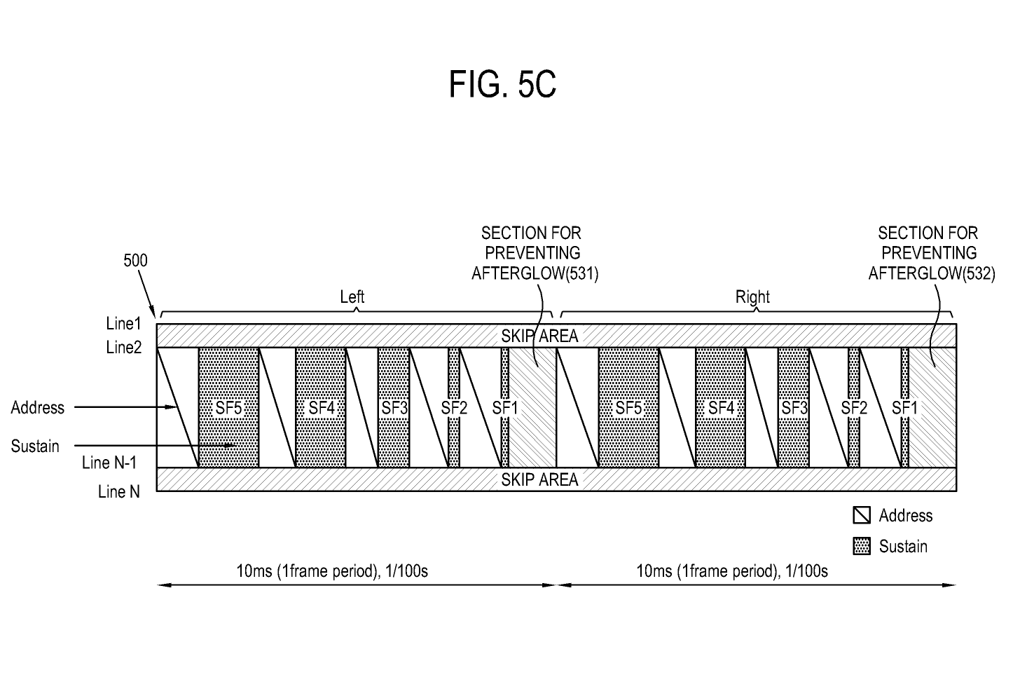

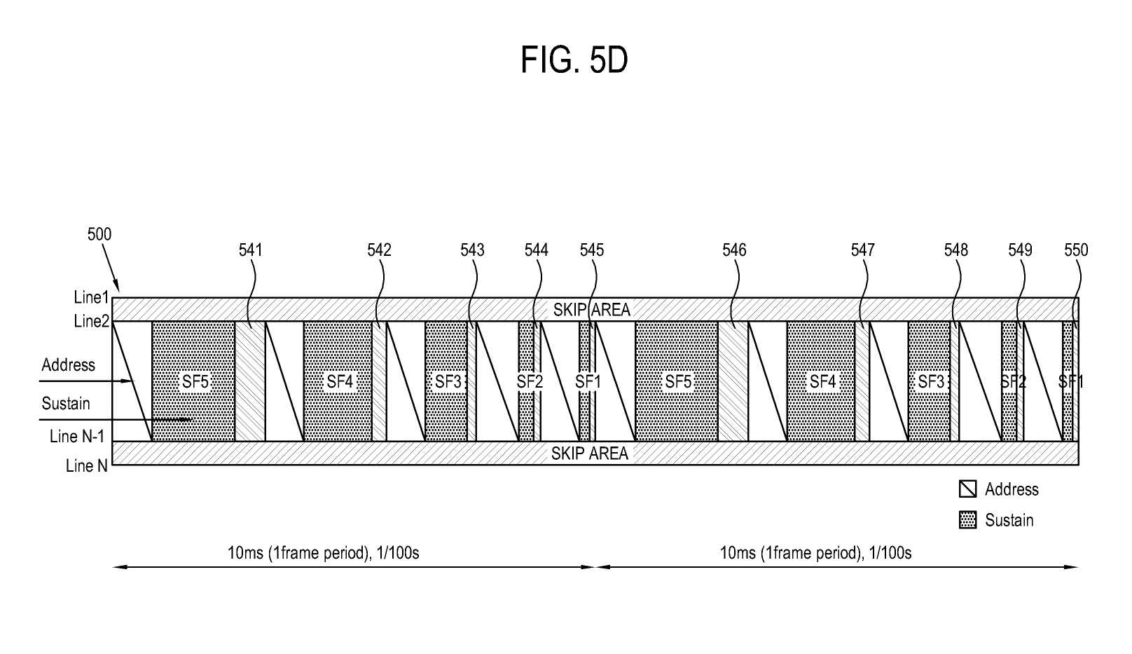

FIG. 5A shows a frame for displaying a three-dimensional (3D) image, driven in general.

In the case where a 3D image is achieved by shutter-type glasses, the display apparatus 100 alternately displays a left-eye image corresponding to a user's left eye and a right-eye image corresponding to a user's right eye. Meanwhile, the shutter-type glasses are driven to open a view of the left eye and close a view of the right eye when the left-eye image is displayed, but to open the view of the right eye and close the view of the left eye when the right-eye image is displayed. If the 3D image is represented by 100 frames per second in a phase alternating line (PAL) system, one frame period for displaying one frame is 10 ms. In this case, each of the left-eye image and the right-eye image is generally driven as being divided into 5 subfields.

Referring to FIG. 5A, a left-eye image 511 and a right-eye image 512 are driven alternately. Further, the driving of each of the left-eye image 511 and the right-eye image 512 is divided into 5 subfields SF5, SF4, SF3, SF2 and SF1. In this case, the left-eye image 511 and the right-eye image 512 are driven by undergoing the subfield SF5, the subfield SF4, the subfield SF3, the subfield SF2, and the subfield SF1 in the sequence similar to that described with reference to FIG. 4A.

FIG. 5B shows a frame for displaying a 3D image, driven according to an exemplary embodiment.

In this exemplary embodiment, the display apparatus 100 may increase the number of subfields constituting a left-eye image and a right-eye image corresponding to a time saved by skipping the driving. Specifically, the number of subfields may be added to divide and drive the left-eye image and the right-eye image such that the time required for the added subfields corresponds to the time saved by partially driving the plasma display panel 110. Referring to FIG. 5B, one subfield is added to a section 521 for the left-eye image, and one subfield is added to a section 522 for the right-eye image. Thus, each of the left-eye image and the right-eye image constituting one frame is divided into 6 subfields.

In this exemplary embodiment of displaying the 3D image, the additional subfields allow minute grayscales to be represented and the image quality enhanced.

FIG. 5C shows a frame 500 for displaying a 3D image, driven according to another exemplary embodiment.

In this exemplary embodiment, a section for preventing an afterglow when the left-eye image and the right-eye image alternate may be added based on the time saved by skipping the driving. Specifically, the section for preventing the afterglow may be added between the left-eye image and the right-eye image such that the time required for driving the added section corresponds to the time saved by partially driving the plasma display panel 110. Referring to FIG. 5C, the section for preventing the afterglow is added to a section 531 in the case of the left-eye image, and to a section 532 in the case of the right-eye image.

When the 3D image is represented through the shutter-type glasses, the left-eye image and the right-eye image are driven alternately. In this case, the afterglow arises as the left-eye image and the right-eye image alternate at a high speed, such that the quality of the 3D image can be deteriorated.

In this exemplary embodiment, the section for preventing the afterglow is added between the left-eye image and the right-eye image such that the time required for driving the added section corresponds to the time saved by skipping the driving, thereby preventing the afterglow and enhancing the quality of the 3D image.

FIG. 5D shows a frame 500 for displaying a 3D image, driven according to still another exemplary embodiment.

In this exemplary embodiment, the display apparatus 100 may increase the sustaining period for the bus electrode with respect to each of the left-eye image and the right-eye image based on the time saved by skipping the driving. Specifically, the periods of sustaining the electric discharges of the respective subfields constituting the left-eye image and the right-eye image may increase by the amount of time saved by partially driving the plasma display panel 110. Referring to FIG. 5D, in the case of the left-eye image, the periods of sustaining the electric charges in the subfields are added as much as the section 541 for the subfield SF5, the section 542 for the subfield SF4, the section 543 for the subfield SF3, the section 544 for the subfield SF2, and the section 545 for the subfield SF1, respectively. Likewise, in the case of the left-eye image, the periods of sustaining the electric charges in the subfields are added as much as the section 546 for the subfield SF5, the section 547 for the subfield SF4, the section 548 for the subfield SF3, the section 549 for the subfield SF2, and the section 550 for the subfield SF1, respectively.

In the case of displaying the 3D image through the shutter-type glasses, one of the shutter-type glasses is alternately closed in response to alternating driving, so that the brightness of an image can be decreased by half.

In this exemplary embodiment, the periods of sustaining the electric discharges of the subfields constituting the left-eye image and the right-eye image increase by as much time as is saved by skipping the driving with respect to a partial area, thereby increasing the brightness of an image.

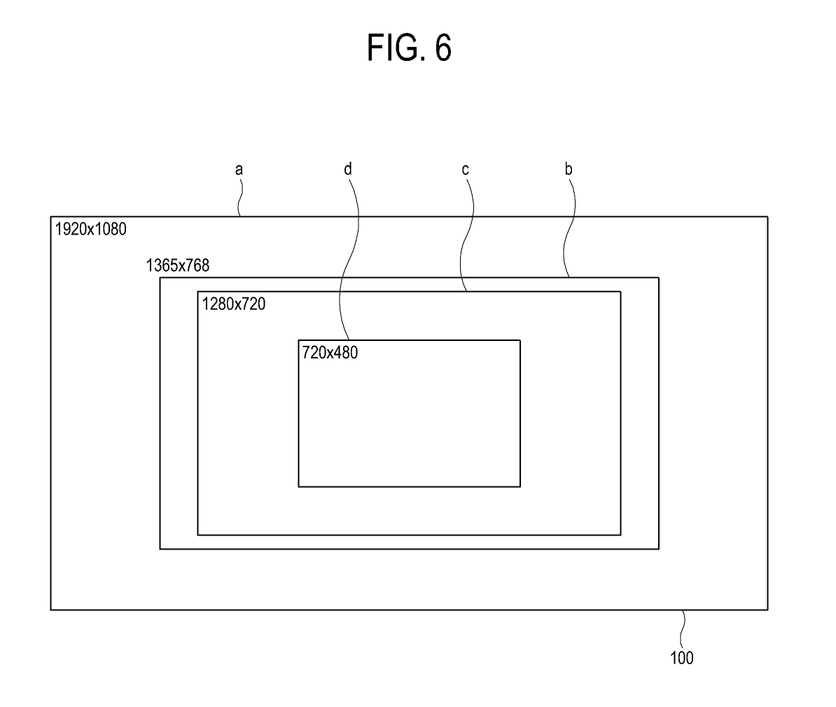

FIG. 6 shows various display areas according to an exemplary embodiment.

According to an exemplary embodiment, an image may be displayed only on a partial area of a screen according to a user's selection. For example, a user may select a high definition (HD) image having a resolution of 1365*768 to be displayed only on a partial area of a screen in a full HD display apparatus, where the full HD display apparatus has a higher resolution than the HD image. In this case, the full HD display apparatus can be utilized by partially driving a plasma display panel to support other resolutions such as an HD resolution, a standard definition (SD) resolution, etc.

Also, the display apparatus may display an image on the basis of a resolution selected by a user, according to one aspect. In this aspect, a display area on the screen is varied depending on its resolution. As shown in FIG. 6, in the case of a full HD image (1920* 1080), this image is displayed in an area a. Further, in the case of an image (1365*768), an image (1280*720) and an image (720*480), images are displayed in areas b, c and d, respectively.

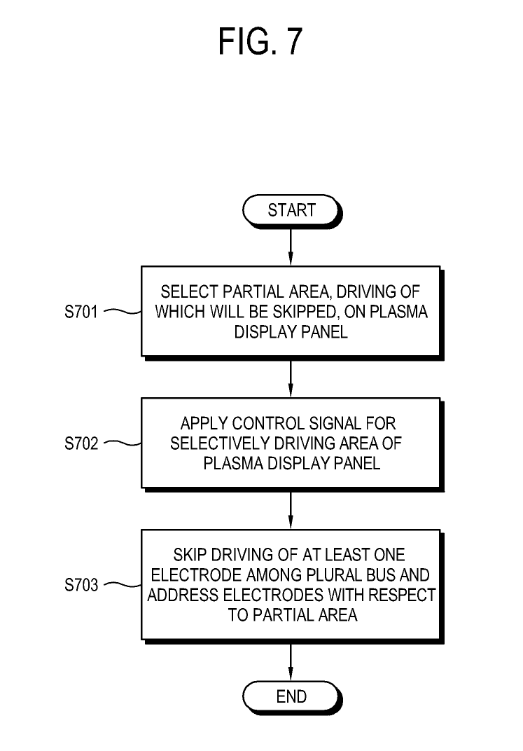

FIG. 7 is a flowchart depicting a process for partially driving a partial region of a display, according to an exemplary embodiment.

At operation S701, the display apparatus 100 selects a partial area of which driving will be excluded on the plasma display panel 110. At this time, the selected area may include an area where no image is displayed due to an unmatched aspect ratio or a certain area selected by a user.

At operation S702, the display apparatus 100 applies a control signal for selectively driving the area of the plasma display panel 110. Specifically, the display apparatus 100 transmits the control signal along with the video signal.

At operation S703, the display apparatus 100 skips driving at least one among the plurality of bus and addressing electrodes.

As described above, a control signal for selectively driving a PDP driving block is applied along with a video signal, so that driving such as addressing and erasing can be excluded with respect to a part where no display is required.

Also, the number of subfields to be driven is additionally increased or a time for sustaining each subfield is increased by an amount of time as was saved by skipping the driving with respect to a partial area, so that quality and the brightness of an image can be enhanced.

Further, with regard to displaying a 3D image, in one aspect, the saved time is used to add and drive a blank section for preventing an afterglow or to increase the sustain time, so that problems of the afterglow and the brightness decrease that arise when the 3D image is displayed can be solved.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a plasma display panel which comprises a plurality of bus electrodes, and a plurality of addressing electrodes intersecting the plurality of bus electrodes to form a display area;
a panel driver which selectively drives the plurality of bus electrodes and the plurality of addressing electrodes; and
a controller which controls the panel driver to exclude from driving at least one of the plurality of bus electrodes and addressing electrodes with respect to a partial area of the plasma display panel.

2. The display apparatus according to claim 1, wherein the partial area of the plasma display panel corresponds to an area other than an effective area of the display area for an input image.

3. The display apparatus according to claim 1, wherein the partial area is located on at least one of a left side and a right side of the plasma display panel, wherein the at least one of the plurality of addressing electrodes is excluded from driving.

4. The display apparatus according to claim 1, wherein the partial area is located on at least one of a top side and a bottom side of the plasma display panel.

5. The display apparatus according to claim 1, wherein the plasma display panel displays an image frame with a number of subfields of discharging times, and wherein the number of subfields per frame is increased by the controller based on an amount of time saved by excluding the driving of the partial area of the plasma display panel.

6. The display apparatus according to claim 1, wherein the plasma display panel displays an image frame, and wherein the image frame comprises a section added by the controller for preventing an afterglow, wherein a size of the section is based on an amount of time saved by excluding the driving of the partial area of the plasma display panel.

7. The display apparatus according to claim 1, wherein the bus electrode includes a sustaining period, and wherein the sustaining period is increased by the controller by an amount of time corresponding to a time saved by excluding the driving of the partial area of the plasma display panel.

8. The display apparatus according to claim 1, wherein the partial area corresponds to an area where no image is displayed, if an aspect ratio of an input image is not similar to an aspect ratio of the plasma display panel.

9. The display apparatus according to claim 1, further comprising a user input unit which allows a user to select the partial area.

10. The display apparatus according to claim 9, wherein the partial area selected through the user input unit is excluded from driving by the controller.

11. A display method comprising:
selecting a partial area from a display area on a plasma display panel, wherein the display area comprises a plurality of bus electrodes and a plurality of addressing electrodes intersecting the plurality of bus electrodes;
driving the plurality of bus electrodes and plurality of addressing electrodes, excluding the partial area, the partial area comprising at least one of the plurality of bus electrodes and addressing electrodes; and
displaying an image frame of the driven display area on the plasma display panel.

12. The display method according to claim 11, further comprising excluding the partial area of the plasma display panel that corresponds to an area other than an effective area of the display area for an input image.

13. The display method according to claim 11, further comprising excluding a partial area located on at least one of a left side and a right side of the plasma display panel, such that the at least one of the addressing electrodes is excluded from driving.

14. The display method according to claim 11, further comprising excluding a partial area located on at least one of a top side and a bottom side of the plasma display panel.

15. The display method according to claim 11, further comprising increasing a number of subfields constituting an image frame based on an amount of time saved by excluding the driving of the partial area of the plasma display panel.

16. The display method according to claim 11, further comprising adding a section to the image frame for preventing an afterglow, wherein a size of the section is based on an amount of time saved by excluding the driving of the partial area of the plasma display panel.

17. The display method according to claim 11, further comprising increasing a sustaining period of the bus electrode by an amount of time corresponding to a time saved by excluding the driving of the partial area of the plasma display panel.

18. The display method according to claim 11, further comprising excluding a partial area that corresponds to an area where no image is displayed, if an aspect ratio of an input image is not similar to an aspect ratio of the plasma display panel.

19. The display method according to claim 11, further comprising allowing a user to select the partial area.

20. The display method according to claim 19, further comprising excluding the partial area selected by user from driving.
